(19) United States
(12) Patent Application Publication
(10) Pub. No.: US 2016/0210599 A1
(43) Pub. Date: Jul. 21, 2016

(54) Automated Payment System for Consumer Bills

(71) Applicant: Creditivity, LLC, Philadelphia, PA (US)

(72) Inventor: James F. Liberi, Haverford, PA (US)

(73) Assignee: Creditivity, LLC, Philadelphia, PA (US)

(21) Appl. No.: 14/996,716

(22) Filed: Jan. 15, 2016

Related U.S. Application Data
(60) Provisional application No. 62/103,983, filed on Jan. 15, 2015.

(51) Int. Cl. G06Q 20/10

(52) U.S. Cl. CPC G06Q 20/102

(57) ABSTRACT

The present invention provides methods and system for an automated payment platform that enables consumers to use a single personal credit cards for payment of multiple consumer's personal bills, such as mortgages and automobile loans. An online account created by the consumer allows the consumer to pay these charges without incurring a significant transaction fee and benefiting from rewards or bonus points associated with the credit card.

### CROSS-REFERENCE TO RELATED APPLICATIONS

This application claims the benefit of U.S. Provisional Application No. 62/103,983, tiled Jan. 15, 2015 and incorporated by reference in its entirety.

### BACKGROUND

1. Field of Invention

The present invention relates to the field of financial data processing, and in particular it relates to payment instruments used by merchants for consumers.

2. Background

Electronic payments and financial transactions are routinely made using credit cards by individuals, between individuals and corporate entities or by corporate entities. These credit card transactions occur on a daily, weekly, and monthly basis. Typically, such payments or transactions may be sent together with payment information including the parties to the transaction, and the amount over the internet via a secured bank account.

Credit card accounts are well known, and a consistent feature of credit card accounts is the high fees charged to merchants by credit card issuers. To increase the rate of use of credit cards and correspondingly, the rate of accumulation of merchant fees, credit card issuers have traditionally offered credit card holders with reward features of various kinds as an incentive to transact on the credit card account more frequently. Traditional credit card rewards programs include periodic cash back credits to the credit card account, frequent flier miles, and points that may be exchanged directly for goods and services.

There are several credit card rewards programs and in particular to credit card rewards programs incorporating an investment. For example, U.S. Pat. App. No. 200150317665 discloses investing in precious metals; U.S. Pat. No. 5,787,404 teaches a credit card rewards program that supports contribution to a retirement account or other long term investment fund. Similarly, U.S. Pat. No. 6,895,386 teaches a credit card rewards program that provides periodic purchases of a stock, and U.S. Pat. No. 6,941,279 teaches a credit card rewards program that provides periodic purchases of a mutual fund.

While this payment process may be sufficient for the purpose of an individual payment, it may not provide an efficient process for multiple payments having additional details useful to the parties to the transaction.

Sending information on individual transactions may be unreliable under continuous or multiple payments by individuals, especially if large numbers of payments or transactions are taking place. Furthermore, improving the usability and customer experience is important, especially for private individuals and so such financial systems and products may require additional enhancements to encourage their continued or expanded use.

Therefore, a system and method is required that overcomes these problems.

### SUMMARY

The present invention is directed to meeting the foregoing needs by providing a simple and convenient method for the payment of a consumer's bills, such as mortgages and automobile loans through a single, online account established by the consumer, without incurring the substantial transaction charges typically associated with the use of cash advances on their credit card. By using the automated payment platform of the present invention, the consumer also will benefit from any “rewards” or “bonus” points typically associated with credit card use.

The methods of the invention may be used in consumer credit card payment of personal bills, corporate credit card payments for a business, or general payment of consumer bills by an entity.

### BRIEF DESCRIPTION OF THE FIGURES

FIG. 1 shows a schematic representation of the steps used by a consumer utilizing the method.

FIG. 2 shows a schematic representation of the processing steps and the relationships between institutions in completing the payment to creditors.

### DETAILED DESCRIPTION

### Definitions

Account Information refers to creditor information provided by the consumer to complete the payment process. This includes the creditor's name, the creditor's address, the amount to be paid to a specific creditor, any rewards or bonus points associated with the use of the card.

An Acquiring Bank enters into a contract with a merchant through a merchant account to allow the business to accept payments by payment cards such as credit or debit cards.

Company refers io the entity managing the automated platform and offerin this service to consumers.

A Consumer is a purchaser of a good or service in retail, usually an end user in a distribution chain of goods or services.

The term Credit Card refers to an electronic instrument issued by a financial institution giving the holder an option to borrow funds, usually at the point of sale. Credit Cards charge interest and are primarily used for short-term financing. Interest usually begins one month after a purchase is made and borrowing limits are pre-set according to the individual's credit rating.

A Creditor or Payee is an entity such as a person or company that extends credit by giving another entity permission to borrow money if it is paid back at a later date. Creditors such as a bank or finance company have legal contracts with the borrower granting the lender the right to claim any of the debtor's real assets such as real estate or automobile if the borrower fails to pay back the loan.

An omnibus Account is an account in which money or securities for more than one beneficial owner are commingled by a custodian or a sub-custodian.

Payment instrument refers, in part, to any electronic instrument such as a credit card, debit card or pre-payment card. A Payment Instrument also refers to any digital or virtual currency, digital or virtual currency incorporating cryptography for security such as cryptocurrency. An example of digital currency would be a payment instrument such as, but not limited to, bitcoin.

Payment System refers to a financial system supporting the transfer of funds from a supplier (bank) to the users (borrowers), or from payers to the payees, usually through the exchange of debits and credits among financial institutions. Payment systems consists of a paper-based mechanism for handling checks and drafts, and a paperless mechanism (such as an electronic fund transfer) for handling electronic commerce transactions.

Payment Processor is a company, often a third party, appointed by a merchant to handle transactions from various channels such as credit cards and debit cards by merchant acquiring banks.

A Vendor is the party in a supply chain that makes or supplies goods or services available to individual or corporate consumers. A Vendor is typically used to describe the entity that is paid for the goods or services, rather than the manufacturer of the goods. However, a Vendor can be both the supplier of goods (seller) and the manufacturer

### DESCRIPTION OF THE EMBODIMENTS

The detailed description is described with reference to the accompanying figures.

The present invention provides a system for automated payment through the use of communication devices. Consumers are able to easily and seamlessly handle their financial transactions using their financial accounts with personal computers connected to the internet and/or using smart phones connected to a mobile wireless network, other devices include, but not limited to, desk-top computers, laptop computers, mobile phones and handheld tablets. In addition with an ever increasing number of consumable items and services available for purchase in the marketplace particularly in the electronic marketplace via the internet, the present invention allows these consumable items and services to be paid by securely transferring payment information over the same communication devices without extensive efforts in bookkeeping or accounting. This payment method reduces a percentage of cash and check transactions in the marketplace and consolidates some or all transactions involving credit cards or similar instruments.

With the widespread accessibility of payment instruments, individuals and corporations use multiple payment instruments to orchestrate payment of their expenses. Further, balancing the use of these instruments and any restrictions such as age or credit history can become tedious.

The present invention provides a system comprising an automated platform whereby consumers such as individuals, companies, or government entity use their preferred type of payment instrument such as personal credit cards or corporate cards for satisfying payment of their personal bills or other incurred debits. The platform is not limited to consumables, but incorporates purchases such as, but not limited to, mortgages or automobile loans.

Accordingly, individual or corporate consumers create an online account for managing the payment of all purchases, without incurring the substantial transaction charges typically associated with the use of cash advances on a credit card. Further, utilizing the online account in the present system benefits the consumer with any “rewards” or “bonus” points associated with credit card use.

After opening an online account, the consumer is able to utilize the payment platform by visiting a secure web site offered through the Company. Alternatively, the consumer can access the service through a secure mobile application. Here, the consumer enters specific financial information associated with the particular credit card or other financial instrument to be used for satisfying the payments. The consumer also enters which financial obligations receive payments and the amounts to be satisfied, along with the name and address of one or more creditors to be paid. This information is transmitted through the website or mobile application via the internet to the Company's banking partner, and simultaneously through the Company's automated payment processing system where a charge is taken from the consumer's credit card or other designated financial instrument.

In one embodiment, the funds designated for payment are then sent by the issuer hank of the consumer's card are held in the Company's designated omnibus account at the Company's partner bank After a specified holding time period as determined by the Company, the funds are considered to be cleared and eligible to be paid from the omnibus account to the pre-designated creditors in the amounts and terms requested by the consumer through their online account instructions with the remaining amounts for the service fees payable to the Company.

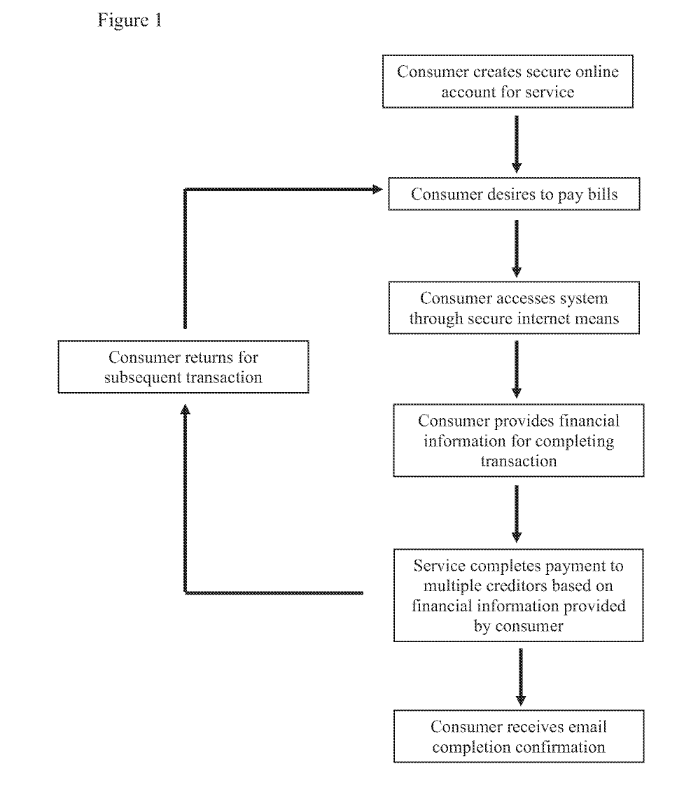

A consumer using the service to pay multiple creditors in a single transaction is represented in FIG. 1. Multiple creditors are easily and seamlessly paid by utilizing the secured process described herein. After creating an account and registering with the Company, the consumer logs into a secure computer, secure mobile application or other device allowing access to the internet. With successful confirmation of a unique password and/or other known protection means, the consumer is directed to input information related to the transaction. This includes financial information regarding payees, specific bills, and amounts to be paid with the transaction. In addition to all related financial information such as, but not limited to, the name and address of the creditor, the consumer is notified of any rewards or bonus points associated with the use of their credit card with this transaction (together “Account Information”). Successful processing of the payment to multiple creditors as specified by the consumer is finalized and the transaction is completed through the payment system. Subsequent transactions by the consumer are completed with access through the secure internet system.

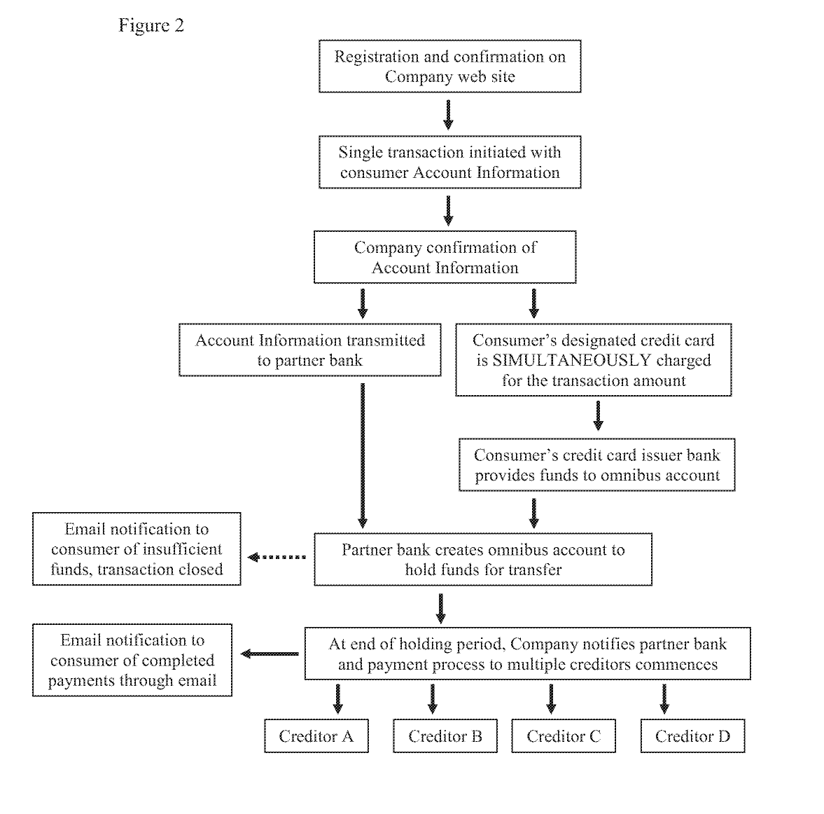

FIG. 2 provides a detailed schematic depicting the interaction between the institutions involved in completing a single transaction. In the first step, confirmation of a valid registration of the consumer with the Company is accepted through a secure registration process using the Company's web site. The consumer provides Account Information for the transaction. This Account Information is confirmed by the Company and transmitted to the Company's banking partner, a designate payment processing service provider, or equivalent. Simultaneously, a charge in the amount of the transaction is taken against the consumer's designated credit card using the Company's automated payment processing system. The funds which includes an aggregate amount for payment of the designated creditors and the fee due the Company are sent by the issuer bank of the consumer's credit card to the Company's omnibus account at the Company's partner bank. The funds remain in this account during a holding period as determined by the Company for proper clearance. Funds deposited in the omnibus account may be held by the Company before any payment for up to five (5) days to ensure security and other purposes in the transfer. The Company then causes payments to be issued to the creditors designated by the consumers in the respective amounts, net of any service fees payable to the Company, from funds on deposit at the partners omnibus account through the Company's banking partner, a designate payment processing service provider, or equivalent. Payment to the designated creditor is completed prior to the sixth (6^{th}) day following deposit in the omnibus account.

If the consumer's designated credit card or an aggregate amount to be charged is not approved during the clearance period, the consumer will be automatically notified via email and offered an opportunity to submit a secondary card, optionally an additional fee may be charged to the consumer by the Company. If the consumer's alternative credit card or other payment instrument is refused or if the consumer does not rectify the refusal within three (3) business days from notification of the refusal the transaction is closed.

With the completion of payments to the designated creditors, the Company automatically notifies the consumer through an email or push notification to the consumers computer or mobile device, completing a single transaction. The system can be structured to automatically repeat transactions on a monthly or other pre-determined interval. With multiple transactions repeated over a designated interval, the Account Information for each transaction may be modified by the consumer with appropriate confirmation of the available funds as described above.

Methods illustrated herein may suitably be practiced in the absence of any element or elements, limitation or limitations, not specifically disclosed herein. The terms and expressions used herein have been used as terms of description and not of limitation, and there is no intention in the use of such terms of excluding any equivalents of the features shown and described or portions thereof. It is recognized that various modification are possible within the scope of the invention claimed. Thus, it should be understood that although the present invention has been specifically disclosed by preferred embodiments and other features, modification and variation of the invention embodied therein herein disclosed may be used by those skilled in the art, and that such modification and variations are considered to be within the scope of this invention.

The invention has been described broadly and generically herein. Each of the narrower species and sub-generic grouping falling within the generic disclosure also form part of the methods. This includes the generic description of the methods with a proviso or negative limitation that removing any subject matter from the genus, regardless of whether or not the excised material is specifically recited herein.

1. A method to pay multiple financial obligations using an automated payment system comprising:
a. providing wireless access by registered consumers to an automated payment platform;
b. inputting financial information sufficient to complete a transaction with designated creditors;
c. submitting a payment instrument to complete the transaction; and
d. processing the financial information wherein said processing provides payment to multiple designated creditors.

2. The method of claim 1 wherein the wireless access is selected from the group consisting of a desk-top computer, laptop computer, mobile phone and handheld tablet.

3. The method of claim 1 wherein the egistered consumer is an individual person or company.

4. The method of claim 1 wherein the financial obligation is a debit for consumables.

5. The method of claim 1 wherein the financial obligation is a mortgage or rent.

6. The method of claim 1 wherein the financial obligation is a student loan.

7. The method of claim 1 wherein the financial obligation is utilities.

8. The method of claim 1 wherein the financial obligation is an automobile payment.

9. The method of claim 1 wherein the financial information is Account Information.

10. The method of claim 1 wherein the payment instrument is selected from the group consisting of personal credit cards, debit cards, corporate cards, pre-payment cards, digital currency cryptocurrency or any combination thereof.

11. The method of claim 1 wherein the processing comprises simultaneously:
a. transmitting the financial information to a partner bank;
b. charging consumer's designated payment instrument; and
c. creating an omnibus account for holding transactional funds over a clearance time period.

12. The method of claim 11 wherein the payment instrument is selected from the group consisting of personal credit cards, debit cards, corporate cards, pre-payment cards, digital currency and cryptocurrency.

13. The method of claim 11 wherein the partner bank creates the omnibus account.

14. The method of claim 11 wherein the time period is up to 5 days.

15. The method of claim 1 having an additional step of sending an email notification to the consumer of successful payment to multiple designated creditors.

16. The method of claim 1 having the additional step of automatically repeating steps a through d.
